(19) United States
(12) Patent Application Publication
(10) Pub. No.: US 2004/0075847 A1
(43) Pub. Date: Apr. 22, 2004

(54) Sensor arrangement to determine vehicle height

(76) Inventor: Thomas N. McCracken, Detroit, MI (US)

Correspondence Address: LITTMAN LAW OFFICES, LTD., P.O. BOX 15035 CRYSTAL CITY STATION, ARLINGTON, VA, 22215, US

(21) Appl. No.: 10/273,157

(22) Filed: Oct. 18, 2002

(51) Int. Cl. G01B 11/14

(52) U.S. Cl. 356/622

(57) ABSTRACT

A system where the height of road vehicles can be determined using two vertical columns, one column having a vertical linear array of sensors, facing and aligned with an opposite column having a vertical linear array of sources. The columns are spaced apart enough for the road vehicle to pull in between. The sensors and sources are mounted at increasing height levels until they reach the top of the columns, or a height that is well above any possible maximum height that a road vehicle may have, or height that is needed to be measured. As the vehicle pulls in between the two columns, a computer consecutively tests the sensors starting from the bottom to see which, if any, of the sensors has its light source blocked. The accumulated number of blocked light sensors is counted to reveal the height of that portion of the vehicle between the columns.

### BACKGROUND OF THE INVENTION

1. Field of the Invention

The present invention relates to vehicle height determination, and more particularly to an arrangement of sensors to measure the height of road vehicles, to ensure compliance with height restrictions, and particularly to sensors mounted vertically on one pole and sources mounted on an opposite pole.

2. Description of the Related Art

Devices to detect the maximum height of road vehicles commonly use a single source and sensor that are placed at the maximum allowable height so that if a vehicle that is overheight, it will block the source at that height and the sensor can activate an alarm. Devices of this type are shown in U.S. Pat. No. 4,916,429 to Hicks et al issued Apr. 10, 1990; U.S. Pat. No. 3,896,414 to Rulo issued Jul. 22, 1975 and U.S. Pat. No. 2,366,152 to Lauterbach issued Dec. 26, 1944.

Also, U.S. Pat. No. 4,284,971 to Lowery et al issued on Aug. 18, 1981 uses an arrangement similar to Hicks et al, but has more than one set of sensors spaced at different locations along the roadway.

The present invention uses multiple sensors and matching sources arranged vertically between a point well below the height of any vehicle to the maximum height of any vehicle and provide an actual height measurement of the highest point. The sources on one pole are on one side and the sensors are on another pole on the other side of the vehicle.

Other devices used to measure the maximum height of road vehicles commonly use a single source and sensor that depend on the vehicle reflecting the light from the source to the sensor to determine the height of the vehicle, such as is taught in U.S. Pat. No. 6,195,019 to Nagura issued Feb. 27, 2001. The present invention depends on the light source being blocked by the vehicle and the sensors detecting darkness.

Other devices measure the height of objects that the vehicle is to go under such as bridges via light sources and sensors mounted on the vehicle such as in U.S. Pat. No. 3,716,863 to Roth issued Feb. 13, 1973.

Other systems measure and warn the driver of a vehicle that the vehicle height is two high using a radio transmitter on the bridge or overhang and a radio receiver in the vehicle such as U.S. Pat. No. 3,419,847 to Bonney issued Dec. 31, 1968.

Also, other devices that measure the height of vehicles use a single sensor such as a video camera and use image processing to separate the vehicle (obstacle) from the background as in U.S. Pat. No. 5,331,312 to Kudoh issued Jul. 19, 1994. Likewise, U.S. Pat. No. 5,392,034 to Kuwagaki issued Feb. 21, 1995 discloses a vertical arrangement of multiple light sensors and light sources on separate poles on opposite sides of the road, that take a profile, but not a height measurement, of a vehicle in transit down the road.

Other devices that measure the height of vehicles using a single sensor include U.S. Pat. No. 5,546,188 to Wangler et al issued Aug. 13, 1996; U.S. Pat. No. 5,793,491 to Wangler et al issued Aug. 11, 1998; U.S. Pat. No. 5,896,190 to Wangler et al. Apr. 20, 1999. These devices appear to depend on reflection from the vehicle rather than a blocking of light from source to sensor.

It would be desirable to have a device to measure maximum height of a vehicle using multiple sensors and corresponding multiple light sources in vertical columns on either side of the vehicle where the measurement is done through a successive counting of the sensors at each height that is dark or blocked, which process includes a time delay. Such an arrangement overcomes the problems of false height readings due to birds or antennas. Such an arrangement allows the measurement of variety of vehicles having different or varying heights.

None of the above inventions and patents, taken either singularly or in combination, is seen to describe the instant invention as claimed. Thus, an arrangement of a plurality of sensors to determine an actual measurement of maximum vehicle height solving the aforementioned problems is desired.

### SUMMARY OF THE INVENTION

The present invention is a system where the height of road vehicles can be determined using two vertical columns in which one column has a vertical linear array of sensors facing and aligned with an opposite column having a vertical linear array of sources. The columns are spaced apart enough for a road vehicle to pull in between. Each of the vertical arrays of sensors and corresponding sources are mounted at increasingly consecutive height levels until they reach the top of the columns or a height that is above any possible maximum height that a road vehicle may have or a height that is needed to be measured.

In operation, as the road vehicle pulls up in between the two columns, a computer consecutively tests the sensors starting from the bottom to see which of the sensors has its light source blocked or is dark. The accumulated number of light sensors that has its corresponding light source blocked is counted with respect to the distance between each light source and reveals the height of that portion of the vehicle that is between the columns. It is then important for the driver of the road vehicle to pull up through the two columns far enough to measure the highest point of the vehicle.

Generally, the first encountered portions of the vehicle may not be the highest point of the vehicle structure. An operator or driver can use both a visual sighting and a reading from the height measurement display panel to judge if the highest point of the vehicle has pulled in between the two columns. When the maximum height of the vehicle has been read, it can be compared to ensure that it is below any height restrictions of the road. Such overheight road vehicles can be barred from travel on the road. Thus, accidents between vehicles and low bridges or overhangs are prevented.

Optionally, the system can include a mat or plate of the kind typically used to provide vehicle weight measurements. Optionally, the system can be used at drive through restaurants etc. where a roof overhang provides a limit on the vehicle height. The system can be designed to be more automated by having the computer compare the height readings to maximum heights and provide warning alarms or gate closures. Optionally, the computer in the system can be physically included inside the sensor column.

Optionally, a remote computer can be connected wirelessly to the computer inside the sensor column making the maximum height measurements. Also, the computer inside the sensor column can create and store a log of each maximum height of each vehicle passing through the columns. The computer inside the sensor column can also be connected wirelessly to the maximum height display, alarm or gate closing device.

Accordingly, it is a principal object of the invention to provide a sensor arrangement to determine vehicle height that can determine the maximum height of a variety of different and varying height vehicles.

It is another object of the invention to provide a sensor arrangement to determine vehicle height that is not prone to errors caused by birds or vehicle antennas.

It is a further object of the invention to provide a sensor arrangement to determine the maximum vehicle height accurately at whatever portion of the vehicle is highest.

Still another object of the invention is to provide a sensor arrangement to determine vehicle height using a successive approximation of the vertical height of a plurality of sensors that are triggered by the body of the vehicle which blocks a certain number of light sources.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, three dimensional, perspective view of an arrangement of sensors and sources to determine vehicle height according to the present invention.

FIG. 2 is another three dimensional, perspective view of an arrangement of sensors and sources like FIG. 1 in which the vehicle to be measured is in a different position.

FIGS. 3A and 3B are a flow diagram of the algorithm used by the computer to calculate the height of the road vehicle.

FIG. 4 is a block diagram of the computer and its attached hardware and sensors.

FIG. 5 is a block diagram of a remote computer and its attached hardware that receives and logs vehicle height information.

FIG. 6 is a flow diagram of the algorithm used by the remote computer for logging the maximum height of all the vehicles passing through the columns.

Similar reference characters denote corresponding features consistently throughout the attached drawings.

### DETAILED DESCRIPTION OF THE PREFERRED EMBODIMENTS

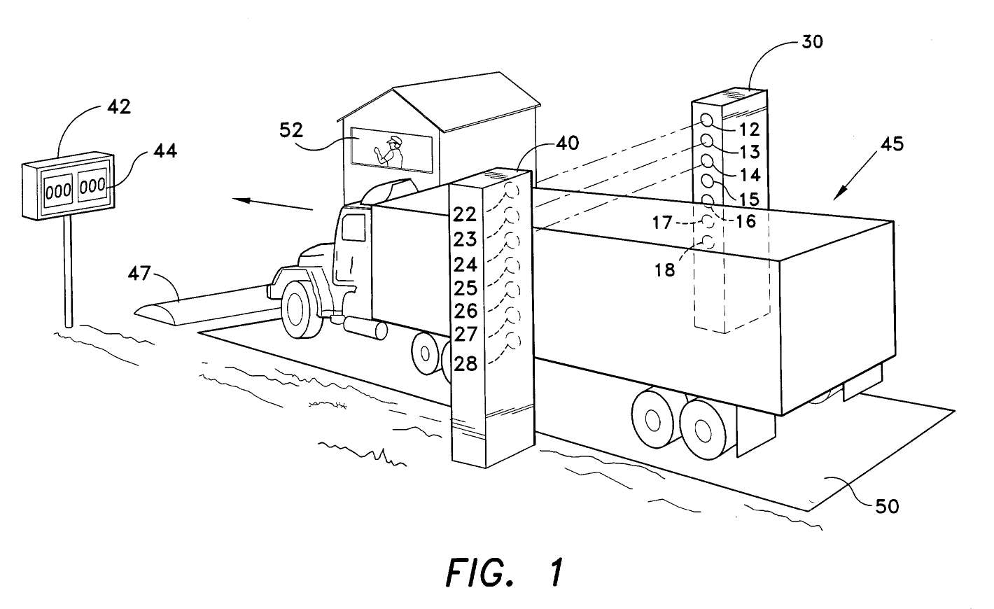

FIG. 1 shows a three dimensional perspective view of a vertical arrangement of sensors 12-18 on one vertical column 30 on one side of the vehicle 45 to be measured and a vertical arrangement of light sources 22-28 on another vertical column 40 on the other side of the vehicle 45 to be measured. The light sensors 12-18 and sources 22-28 are arranged to be aligned with each other at measured incremental heights. A light source 22 and its corresponding sensor 12 will be essentially the exact same height from level ground. Thus, when a vehicle 45 begins to drive through columns, 30 and 40, it will block only a certain number of lights from light sources 28, 27 from reaching its light sensor 18, 17.

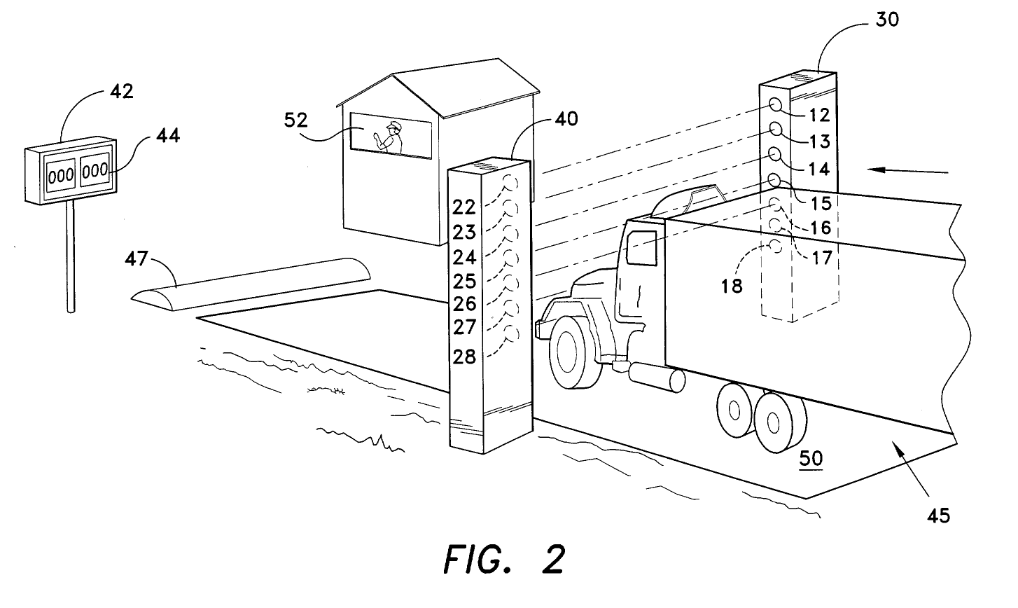

As shown in FIG. 2, a front part of the truck 45 to be measured pulls in first and only the first two light sensors 18, 17 are dark i.e., have their light sources blocked. Thus, the computer will recognize that the truck's 45 current height is only a number of feet and inches corresponding to the front part of the truck 45, that blocks light sources 27, 28. The front part of a truck 45 will not be overheight and not trigger any alarm.

As shown in FIG. 1, the truck 45 is required to pull further through the two columns 30, 40. The truck 45 at its highest point will have more sensors 18-15 be dark corresponding to a taller part of the truck 45. The truck 45 can be required to move its whole portion through the columns 30, 40 and thus any part of the truck 45 that is too tall would trigger an overheight alarm. At any point as in FIGS. 1 or 2 or as the whole truck 45 pulls through the two columns 30, 40, a digital display 44 can provide a reading of the height of the truck 45.

If the system is used at a station at the side of the highway for measuring trucks, the station may include a weight sensor 50 for weight measurement, weight display 42, and a bump 47 in the road to let the driver of the truck 45 know the best position for a weight and/or height measurement.

Sensors 12-18 and sources 22-28 as shown in FIGS. 1 and 2 are arranged vertically each spaced 0.5″, 0.75″ or 1″ inch apart from each other. The sensors 12-18 and sources 22-28 are placed starting at a height corresponding to a height just below the lowest height of a vehicle that is expected to be measured. This height might be about 3.9 feet high for a car with the smallest height of 4 feet. Enough of the sensors 12-18 and sources 22-28 are placed at the successive heights mentioned above until the highest point is reached. The highest point would be a little above or at the maximum height allowed for a vehicle by law or at the limits of the road due to bridges, overhangs etc. For example, sensor 18 and light source 28 would be placed 4 feet from the ground, sensor 17 and light source 27 would be placed 4 feet 1 inch from the ground and sensor 16 and light source 26 would be 4 feet 2 inches from the ground and so on. Also, if the lowest bridge on the road is 14 feet then the highest sensor and corresponding source would be 14 feet 1 inch from the ground. The number of sensors is equal to the height of the highest sensor minus the height of the lowest sensor divided by the distance between each sensor.

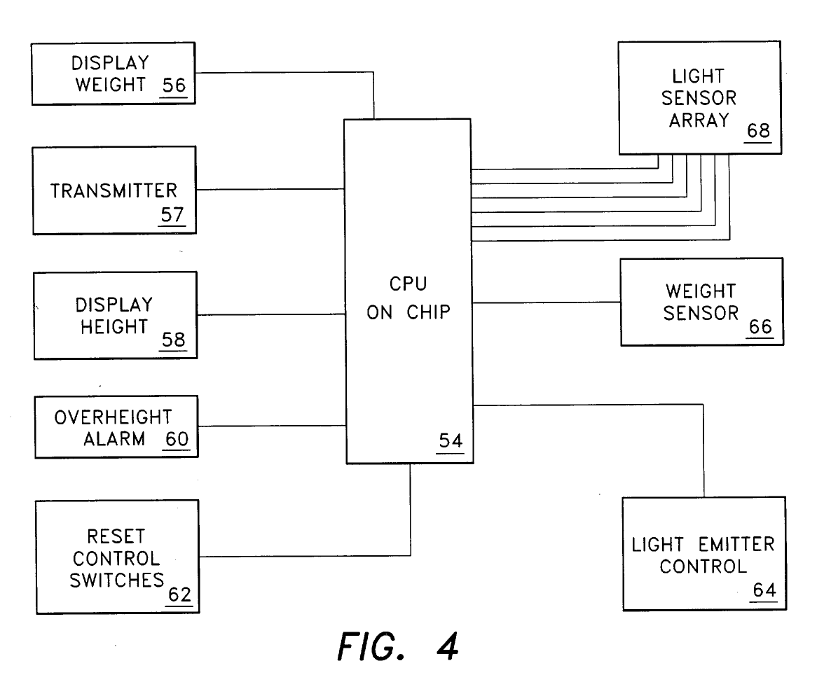

The CPU 54 of FIG. 4 for evaluating the height and optionally the weight measurements can be incorporated into the sensor column 30 of FIGS. 1 and 2. The CPU 54 can be connected wirelessly through a wireless data link to the light sources 22-28, station computer 52, display 44, display 42, weight sensor 50 and drop gate (not shown).

In FIG. 4 reset and control switches 62 can put CPU 54 in a reset mode which includes an operational check or validity check of the sensors. This validity check of the sensors is done by setting each one of the individual sources on one at a time and checking that each of the corresponding sensors are activated by the corresponding sources while no objects are allowed between the columns.

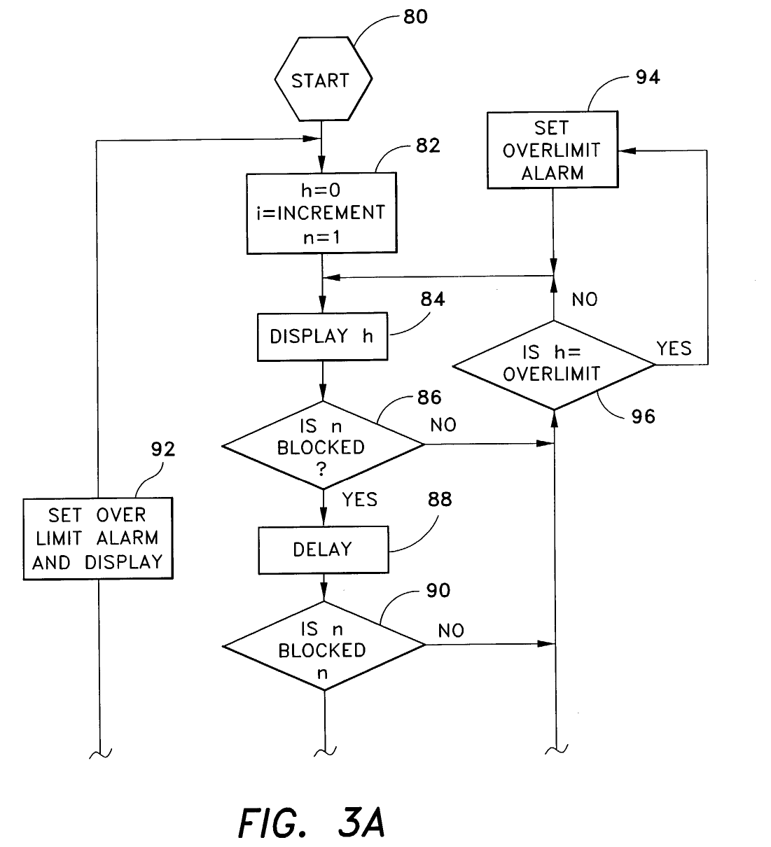

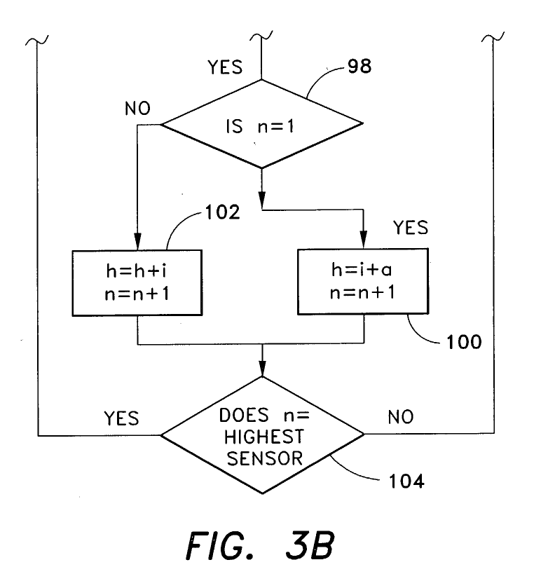

FIGS. 3A and 3B together show a flow diagram showing the steps that the CPU 54 in FIG. 4 takes in calculating the height of the vehicle. CPU 54 tests each of the sensors along the column successively while accumulating a height value until the first sensor that is not blocked is found. The variables used in FIGS. 3A and 3B are: n is the number of the sensor being tested; h is the value of the height in inches, feet or meters; i is the distance in inches, feet or meters between each sensor and a is the actual height of the first sensor.

In FIGS. 3A and 3B, the algorithm starts at START 80 when the computer 54 has finished resetting or has finished a previous measurement. Next at step 82 the computer sets height h equal to zero, sets i equal to the increment which is the spacing between the sensors and sets n equal to 1 or the first sensor. Next at step 84 the computer displays h on the height display which at first is 0. Next at step 86 the computer checks the nth sensor to see if it is blocked. If the nth sensor is not blocked then the value of h is compared at step 96 for an overheight value and an overheight alarm is set at step 94 if h is overheight. Then h is displayed at step 84 and the whole process is started over again. If the nth sensor is blocked then a delay at step 88 is invoked and a possible object is being measured. Next at step 90, the computer checks the same nth sensor again to see if it is blocked. If the nth sensor is blocked then the object being measured is at least as high as the nth sensor. If the nth sensor is not blocked after the delay, then an antenna or bird may have falsely activated the nth sensor The value of h is checked at step 96 to see if it is overheight, if h is overheight the overheight alarm is set at step 94. Then the process starts over at the displaying of h at step 84.

If the nth sensor is blocked (an object is being measured) and n is equal to 1 at step 98 then h is set equal to i plus a and n is incremented by 1 at step 100. If the nth sensor is blocked and n is not equal to 1 at step 98 then h is set equal to the sum of the previous value of h plus the increment i and n is incremented by 1 at step 102. Steps 100 and 102 are the only steps where h is accumulated. Next at step 104, if n is not equal to the last sensor then the value of h is tested to see if its value is overheight at step 96. If h is overheight the overheight alarm is set at step 94. Next h is displayed again at step 84 and the rest of the process is continued again. However, if n is equal to the last sensor at step 104 the overheight alarm is set and the height h is displayed at step 92 and the whole process of measuring is started again from the beginning at step 80.

The delay at step 88 and/or successive checking of sensors with accumulation of height (as in steps 82, 84, 86, 88, 90, 98, 100, 102, 104, 96, 94) above serve to avoid the false readings caused by an object like a bird that might pass through the columns 30, 40 in FIG. 1. If a bird passes through the columns 30, 40 it will block the light for only one or two sensors 13, 14 more likely in the middle of the vertical columns. Since the first sensor 18 does not have it's light blocked in this situation, then the algorithm above will never sense the bird. In case the bird flies through the columns 30, 40 at the height of the first sensor 18 then the delay at step 88 in FIG. 3A should be long enough for the bird to finish flying through the columns 30, 40 in FIGS. 1 and 2 and not be detected on the second check 90 in FIG. 3A of the same sensor 18 in FIG. 1.

Thus, the false reading of the height of a bird is avoided. Other objects like the bird might be a visor or scoop that extends out horizontally from the rear roof of a vehicle. Like the bird such an object has no height below it so no false measurement reading will be made in the same way as the bird example above.

In the case of an antenna that might not be damaged by or damage a bridge or overhang, the antenna has further vertical height to be measured. However, the antenna is thin enough that the delay 88 in FIG. 3A and the movement of the vehicle 45 through the columns 30, 40 in FIG. 1 will cause the antenna not to be measured.

FIG. 4 shows the arrangement of computer electronics that calculates the height of the vehicle. Reset and control switches 62 provide an operator of the system a means to control, set, reset or validate the system using programs on CPU 54. CPU 54 uses light emitter control 64 and reset control switches 62 to turn on and off the light sources 22-28 in FIG. 1 to allow an operator to shutdown the system or change light source elements or test and align the light sources 22-28 with its corresponding sensor 12-18 by allowing light sources 22-28 to operate one at time instead of all at once as in a normal operating mode as in the routine of FIGS. 3A and 3B.

In FIG. 4, light emitter control 64 can have a microcontroller or other logic device with relays to control the power applied to the light sources. During normal measuring operations light emitter control 64 will either keep all light sources 22-28 in FIG. 1 on all of the time or pulse them on and off at an optimal rate. The pulsing light sources 22-28 can be used to overcome effects of ambient light falsely triggering the sensors 12-18, when testing at step 86 in FIG. 3A for a blocked sensor assumes that a non-dark sensor without a pulsing light (sunlight) is the same as if the sensor was blocked or dark.

In FIG. 4, CPU 54 uses weight sensor 66, 50 in FIGS. 1 and 2, to calculate and provide weight information to the operator via the weight display 56, 42 in FIGS. 1 and 2, in situations where the present invention is used in a road side station that needs weight and height measurement. CPU 54 uses separate inputs from the array of light sensors 68, 12-18 in FIGS. 1 and 2, to calculate and provide to the operator via the height display 58, 44 in FIGS. 1 and 2, information about the height of the vehicle.

In situations where there is no full time operator to check a height display as in a drive through restaurant, the CPU 54 uses separate inputs from the array of light sensors 68, 12-18 in FIGS. 1 and 2, to calculate and provide a signal to an overheight alarm 60, if the height measured is over a predetermined amount. The predetermined amount might be the height of the roof or overhand at the drive through restaurant.

In both situations where a road side station that needs weight and height measurement and uses an attendant or where there is no full time attendant, a drop gate maybe used which is activated by the same signal as the overheight alarm 60, that is generated by CPU 54. The drop gate should be placed at an optimal distance from the columns 30, 40 so that the vehicle 45 can pull through the columns 30, 40 at a position revealing its maximum height, but the drop gate has room to drop down in front of the vehicle. In addition, the drop gate still needs to be placed before the overhang.

In FIG. 4, optionally, CPU 54 can be placed inside sensor column 30 of FIG. 1. In this case it would naturally have wired connections to the light sensors 68 of FIG. 4 or 12-18 of FIGS. 1 and 2 and reset control switches 62 of FIG. 4. CPU 54 can have wired connections to weight display 54, 42 in FIGS. 1 and 2, height display 58, 44 in FIGS. 1 and 2, overheight alarm 60, light emitter control 64 and weight sensor 66, 50 in FIGS. 1 and 2.

In FIG. 4, optionally, CPU 54 can communicate wirelessly over a wireless data link using a transmitter 57 to a remote computer 52 in FIGS. 1 and 2 and to weight display 54, 42 in FIGS. 1 and 2; to height display 58, 44 in FIGS. 1 and 2; to overheight alarm 60; to light emitter control 64 and weight sensor 66, 50 in FIGS. 1 and 2.

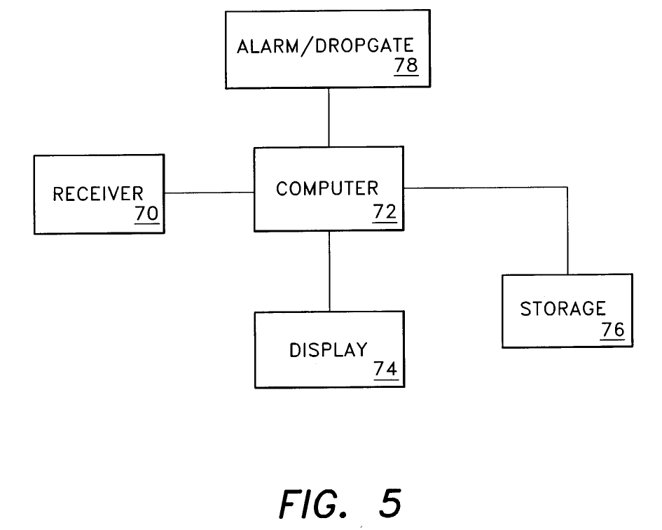

FIG. 5 shows an arrangement of the remote computer 72 and its peripherals. Remote computer 72 can be connected by cable to CPU 54 of FIG. 4 or through a wireless radio link using receiver 70 in FIG. 5 which receives signals from CPU 54 via transmitter 57 in FIG. 4. Remote computer 72 in FIG. 5 provides the operator 52 in FIG. 1 with information on the maximum height and/or weight of the vehicle currently between the columns 30, 40, overheight and overweight alarms and logging information regarding previous vehicles maximum height or weight amounts and vehicle identification which can be displayed on display 74. The remote computer 72 can use permanent storage 76 for storing a log of each of the measured vehicle's maximum height and optionally weight. The remote computer 72 might provide a connection and/or manual control of the overheight alarm and drop gate 78.

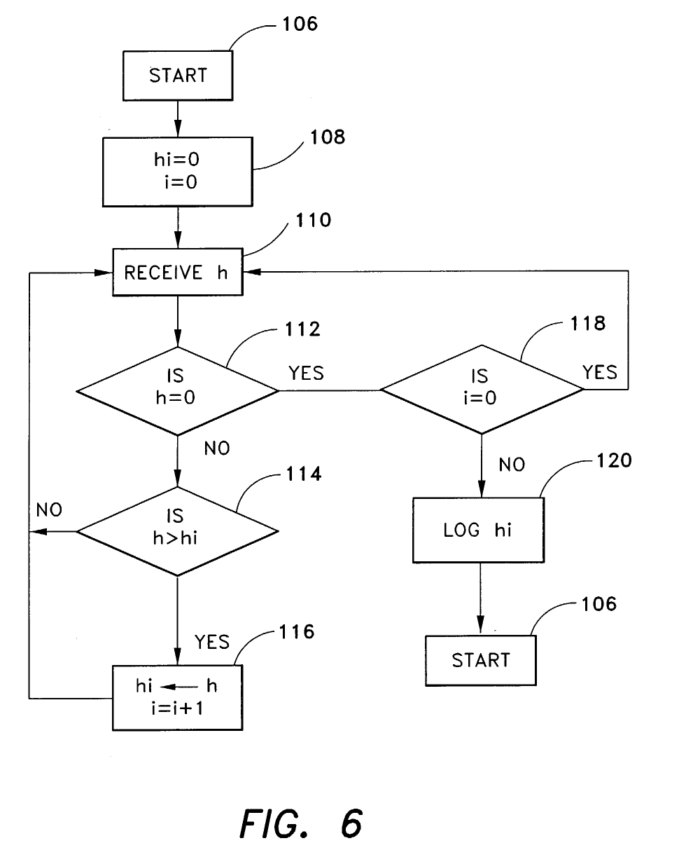

FIG. 6 shows a flow chart of the algorithm that the remote computer 72 in FIG. 5 uses to monitor and record the maximum height of each vehicle 45 in FIG. 1 as it finishes passing through the two columns 30, 40. In FIG. 6, the algorithm starts at step 106, then initializes the values for hi which is value of the maximum height of the vehicle as it finishes passing through the columns; and i is set equal to zero to indicate first entry of a vehicle 45 through the columns 30, 40 in FIG. 1. Next at step 110 in FIG. 6, the value of h, the current or instantaneous height of the vehicle 45 in FIG. 1, is received from CPU 54 in FIG. 4. Next at step 112, h is checked to see if it is zero. If h is equal to zero, then at step 118 i is checked to see if it is equal to zero or the first portion of the vehicle entering through the columns. If i is equal to zero, the vehicle 45 has just started entering the columns 30, 40 in FIG. 1, and at step 110 h needs to be received again. If i is not equal zero, a number of measurements have been received and if h is also equal to zero, then the vehicle has cleared the columns. Then hi and vehicle identification can be logged and stored at step 120. The algorithm is restarted at step 106.

If h is not equal to zero at step 112, then at step 114 h is checked to see if it is larger than the previously recorded value hi for the vehicle. If h is not greater than hi at step 114 then another value of h is received at step 110. If h is greater than hi at step 114 then hi becomes the value of h and i is incremented by 1 at step 116. Therefore, only the largest values of h are stored in hi. Next at step 110, another value of h is received.

It is to be understood that the present invention is not limited to the embodiments described above, but encompasses any and all embodiments within the scope of the following claims.

I claim:

1. A system to determine a vehicle height comprising:
a first vertical column of a plurality of light sources arranged vertically at incremental heights along said first column;
a second vertical column of a plurality of light sensors arranged vertically at incremental heights along said second column;
each of said plurality of light sensors having a corresponding said light source at a same height;
said first and second columns placed on opposite sides of a vehicle path with said sensors facing said light sources;
an electronic display showing height measurement;
an overheight alarm; and
and a computing device;
wherein said vehicle pulls through said first and second columns, and said computing device operates consecutively to determine said height of said vehicle, by successively checking which of said plurality of light sensors are blocked by said vehicle, accumulating a corresponding height of said blocked sensors to provide a display of said vehicle height on said electronic display, and comparing a value of said vehicle height with a maximum value to activate said overheight alarm.

2. A system to determine a vehicle height as claimed in claim 1, further including an audible alarm, wherein said overheight alarm triggers said audible alarm.

3. A system to determine a vehicle height as claimed in claim 2, further comprising a drop gate, wherein said overheight alarm triggers said drop gate.

4. A system to determine a vehicle height as claimed in claim 2 wherein said computing device further comprises a wireless data link to communicate to said light sources, said overheight alarm and said electronic display.

5. A system to determine a vehicle height as claimed in claim 4 wherein said computing device is physically located in said second column.

6. A system to determine a vehicle height as claimed in claim 5, further comprising a remote computer, configured to record a log of a maximum height of each said vehicle that has finished passing through said first and second columns.

7. A system to determine a vehicle height as claimed in claim 6 wherein said remote computer is configured to receive height information from said computing device through said wireless data link.

8. A system to determine a vehicle height as claimed in claim 1, further comprising a drop gate, wherein said overheight alarm triggers said drop gate.

9. A system to determine a vehicle height as claimed in claim 8 wherein said system is configured such that successively checking a blocked sensor includes delaying for a short time and checking again for a blocked light sensor to discriminate between an actual height of said vehicle and an unwanted object.

10. A system to determine a vehicle height as claimed in claim 8 wherein said computing device further comprises a wireless data link to communicate to said light sources, said overheight alarm; said drop gate and said electronic display.

11. A system to determine a vehicle height as claimed in claim 10 wherein said computing device is configured to record a log of a maximum height of each said vehicle that has finished passing through said first and second columns.

12. A system to determine a vehicle height as claimed in claim 1 wherein said light sensors are photovoltaic cells in the infrared light spectrum and said light sources emit light within said infrared light spectrum.

13. A system to determine a vehicle height as claimed in claim 1 wherein said system is configured such that successively checking a blocked sensor includes delaying for a short time and checking again for a blocked light sensor to discriminate between an actual height of said vehicle and an unwanted object.

14. A system to determine a vehicle height as claimed in claim 1 wherein said computing device is physically located in said second column.

15. A system to determine a vehicle height as claimed in claim 14 further comprising a remote computer, configured to record a log of a maximum height of each said vehicle that has finished passing through said first and second columns.

16. A system to determine a vehicle height as claimed in claim 1 wherein said computing device is configured to record a log of a maximum height of each said vehicle that has finished passing through said first and second columns.

17. A method of using a plurality of sensors arranged vertically at consecutive heights along a first column and a plurality of light sources arranged at corresponding heights vertically along a second column placed on an opposite side of a road from the first column for determining a height of a vehicle comprising the steps of;
driving a vehicle through the first and the second columns at sections having a highest and lowest point of the vehicle;
computer checking the plurality of sensors one at time starting from a lowest height sensor to determine if the sensor is blocked;
and if the sensor is blocked, the height is set equal to a distance between each sensor and a previously determined height;
and if a last of the sensors has been checked, generating an alarm and displaying the height and continuing the step checking the plurality of sensors
and if the sensor is not blocked, checking if the height is a maximum height and if so generating an alarm;
otherwise displaying the height and continuing said step of checking the plurality of sensors.

18. A method for determining the height of a vehicle as claimed in claim 17 wherein;
said step of checking said plurality sensors includes the step of delaying for a short time if the sensor is blocked, and checking again if the same sensor is blocked.

19. A method for determining the height of a vehicle as claimed in claim 17, further comprising the step of the computer communicating the heights to a remote computer for the remote computer to determine and log a highest possible height of the vehicle having finished passing through the first and second columns, having the steps of;
setting an initial logged height to zero;
setting an initial number of height readings from the vehicle to zero;
the remote computer receiving from the computer the height of the vehicle;
checking to see if the height is equal to zero;
if the height is equal to zero and the number of height readings is equal to zero then continuing with said step of receiving the height of the vehicle from the computer;
if the number of height readings is not equal to zero storing the logged height for the vehicle permanently;
if the height is not equal to zero then checking if the height is greater than the logged height;
if the height is greater than the logged height then the logged height becomes the value of the height and the number of height readings is incremented by 1 and continuing with said step of receiving; and
if the height is not greater than the logged height then continuing with said step of receiving.

20. A method of using a remote computer to determine and log a highest possible height of a vehicle while said remote computer is connected to a computing device that determines a vehicle height from a plurality of sensors on a vertical column as said vehicle finishes passing by said vertical column comprising the steps of:
setting an initial logged height to zero;
setting an initial number of height readings from the computing device to zero;
said remote computer receiving from the computing device the height of the vehicle;
checking to see if the height is equal to zero;
if the height is equal to zero and the number of height readings is equal to zero, then continuing with said step of receiving said height of the vehicle from the computing device,
if the number of height readings is not equal to zero, storing said logged height for the vehicle permanently;
if the height is not equal to zero, then checking if the height is greater than the logged height;
if the height is greater than the logged height, then the logged height becomes the value of the height, and the number of height readings is incremented by 1 and continuing with the step of receiving; and
if the height is not greater than the logged height then continuing with said step of receiving.
